(19) United States
(12) Patent Application Publication
(10) Pub. No.: US 2015/0121410 A1
(43) Pub. Date: Apr. 30, 2015

(54) METHOD AND A NETWORK FOR DETERMINING USER BEHAVIOR DURING DELIVERY OF VIDEO CONTENT

(71) Applicants: Faqir Zarrar Yousaf, Leimen (DE); Paulo Ferrer Loureiro, Heidelberg (DE); Marco Liebsch, Heidelberg (DE)

(72) Inventors: Faqir Zarrar Yousaf, Leimen (DE); Paulo Ferrer Loureiro, Heidelberg (DE); Marco Liebsch, Heidelberg (DE)

(73) Assignee: NEC EUROPE LTD., Heidelberg (DE)

(21) Appl. No.: 14/387,965

(22) PCT Filed: Mar. 30, 2012
(86) PCT No.: PCT/EP2012/055882

§ 371 Date: Sep. 25, 2014

(51) Int. Cl. H04N 21/6587; H04N 21/258; H04N 21/25; H04N 21/442; H04N 21/2387

(52) U.S. Cl. CPC H04N 21/6587; H04N 21/44204; H04N 21/44218; H04N 21/44222; H04N 21/2387; H04N 21/252; H04N 21/25891
USPC 725/21

(57) ABSTRACT

For allowing an intelligent and/or resource efficient delivery of video content and/or determining of video content popularity and/or user behavior a method for determining user behavior during delivery of video content is claimed, wherein a user is requesting a delivery of a video content from a provider via a network. The method is characterized in that the provider exploits information transmitted between the user and the provider due to the execution of a trick play function by the user for scheduling the delivery and/or determining video content popularity and/or user behavior. Further, an according network is claimed, preferably for carrying out the above mentioned method.

The present invention relates to a method for determining user behavior during delivery of video content, wherein a user is requesting a delivery of a video content from a provider via a network. Further, the present invention relates to a network, wherein a user is requesting a delivery of a video content from a provider via the network.

Recently there has been a proliferation of video content traffic putting immense pressure on the operator's network and resources. At present, video content providers (CP), like YouTube, DailyMotion etc., deliver video content to clients using the same delivery policy with the assumption that the user will view the content from start to finish. Upon a content request, the content server will initially transmit video data at a high rate to quickly fill the client's playout buffer with enough content data to ensure a smooth playback. After the play buffer reaches a specific size in terms of play time, the subsequent video data is then transmitted at a lower constant rate, which is equal to or slightly higher than that the play rate. For reference, see S. Alcock, R. Nelson, “Application Flow Control in YouTube Video Streams”, ACM SIGCOMM Computer Communication Review, Vol. 41, Nr. 2, April 2011. This process has the apparent disadvantage that by the time a user decides a particular content to be of no interest, the entire content or a significant portion of it has already been transferred over the network and downloaded/cached by the UE (User Equipment) resulting in waste of transmission resources as well as network resources, especially over the wireless access link.

One method could be to link the content transmission/delivery rate according to the content popularity. CPs rely on a number of metrics such as view count, number of comments, number of favorites, number of ratings and their correlation for assessing the popularity of a content. For reference, see G. Chatzopoulou, C. Sheng, M. Faloustsos, “A First Step towards Understanding Popularity in YouTube INFOCOM IEEE Conference on Computer Communications Workshops, 2010. However, such an approach can be misleading; for example, an extremely offensive content that solicits a lot of negative comment on the contrary can be ranked as popular. Similarly the view count metric, which is based on the number of requests a video content receives, can be misleading as a widely advertised content may not be considered popular in a different region, for example owing to cultural or business differences. Hence, a user who would request such content may stop watching this content after the first couple of seconds or minutes. A user may also perform trick play, where a user may skip forward to the scene-of-interest and/or the user may repeatedly skip through the content to view specific video segment(s) of interest. However, the existing content popularity methods do not have the granularity to determine the popular segment within a particular content that makes the content popular. Therefore popular segments of a particular content can't be treated differently during delivery process; leading to indiscriminate delivery of the content at normal pace to all users, irrespective of their viewing behavior. This will result in the wastage of network resources such as transmission and bandwidth, and also wastes user buffer resources in case of users that tend to skip often and do not view the content fully.

Current optimization techniques for content delivery tend to limit the delivery of the complete content irrespective of the playback rate on the receiving client. These optimization techniques, e.g. video pacing, throttle the content delivery rate at the sender side when sufficient content packets have been buffered at the client ahead of the playback status. How much to throttle the delivery rate is typically a static setting or roughly calculated according to the estimated throughput and the estimated playback status. Whereas the throughput can be estimated based on a client's feedback, for example reception of TCP (Transmission Control Protocol) ACK or RTCP (Real-Time Transport Control Protocol) Receiver Report, the playback status in case of video content delivery is simply estimated according to the playback rate associated with the selected video codec.

It is an object of the present invention to improve and further develop a method for determining user behavior during delivery of video content and an according network for allowing an intelligent and/or resource efficient delivery of video content and/or determining of video content popularity and/or user behavior.

In accordance with the invention, the aforementioned object is accomplished by a method comprising the features of claim 1 and by a network comprising the features of claim 21.

According to claim 1 the method is characterized in that the provider exploits information transmitted between the user and the provider due to the execution of a trick play function by the user for scheduling the delivery and/or determining video content popularity and/or user behavior.

According to claim 21 the network is characterized in that the provider comprises means for exploiting information transmitted between the user and the provider due to the execution of a trick play function by the user for scheduling the delivery and/or determining video content popularity and/or user behavior.

According to the invention it has been recognized that it is possible to allow, for example, for an intelligent and/or resource efficient delivery of video content by an intelligent scheduling of the delivery by the provider. Concretely, the provider exploits or uses information transmitted between the user and the provider due to the execution of a trick play function by the user. Such information generated due to the execution of a trick play function by the user can be used to schedule the delivery of video content and/or to determine video content popularity and/or user behavior. Determining video content popularity means also determining popularity of sub-segments of video content. Thus, usually no additional information has to be generated for performing the claimed method. It will generally only be necessary to exploit information which is already present during usual delivery processes.

Within a preferred embodiment the exploitation could be performed on a per user basis. Thus, a scheduling of the delivery could be performed depending on a user behavior or user characteristics.

Additionally or alternatively the exploitation could be performed on a per video content basis. Thus, the scheduling of the delivery could depend on video content characteristics.

With regard to a very effective scheduling the provider could record user behavior during trick play while the user is downloading and/or viewing the video content. Such a recording of user behavior enables an effective collecting of relevant trick play information.

Within a further preferred embodiment the information could comprise a message or messages that a browser or an appropriate application on the user side sends towards the provider when the user executes a trick play function. Thus, a type of message or messages could be used which is usually present during known applications.

Further concretely, the message could be generated each time a track slider is advanced beyond or outside a play-out buffer.

Generally, the exploitation could be performed statistically. Different types of exploitation are possible depending on an individual requirement.

Within a further preferred embodiment the exploitation could comprise the determination of a user or group of user behavior or viewing behavior in relation to the video content or video content type. Thus, different users or groups of users could be associated with specific video content and/or a specific video content type, for example political or scientific video content.

A further preferred type of exploitation could comprise the determination of a user or group of user behavior or viewing behavior by setting thresholds on number of skips and subsequently classifying the user and/or classifying the video content. Thus, a user or a group of users could be classified depending on a number of performed skips during trick play.

Within a further preferred embodiment the exploitation could comprise the determination of video content popularity based on the number of times a user executes the trick play function. By such a type of exploitation a simple assessment of video content popularity could be possible.

Within a further refined method the exploitation could comprise the determination of the popularity of sub-segments within a video content based on how many users and/or how many times a user advances forwards and/or backwards to re-view a particular segment of a scene or video content and/or to skip over a particular segment of a segment, scene or video content. By means of such a type of exploitation not only the popularity of a video content as a whole is possible but also an assessment of the popularity of sub-segments within a video content. Based on this exploited information a sophisticated scheduling of delivery of video content could result.

Generally, the exploitation could comprise the possibility of delivering the video content in a differentiated and/or personalized pacing. Different and personalized delivery rates are possible.

Within a further preferred embodiment the exploitation could comprise an estimation of a buffer utilization at a user or UE. Depending on such a buffer utilization the scheduling of the delivery could be planned and/or optimized and/or performed.

Depending for example on the content popularity the provider could deliver content chunks of a definable and/or popular segment of the video content at a higher rate than of other segments. Such a definable and/or popular segment could be a segment after which the user is expected to or might skip forward or backward. Such a segment could be preferred regarding the filling of the play-out buffer.

Alternatively, the definable and/or popular segment could be a segment into which the user is expected to or might skip forward or backward. In this case, content chunks could be transmitted at a higher than average rate in order to preempt an expected skip event.

Within a further preferred embodiment the information transmitted between the user and the provider could comprise a number of skip events and/or a skip location within the video content. Alternatively or additionally the information could comprise the starting and the end point of a skip event within the video content. Such an information could be used for determining the skip size.

Within a further preferred embodiment the information could comprise the skip direction within the video content. Also this type of information will help in assessing video content popularity, for example.

As a result the user could receive a video content stream at normal, variable, increased or decreased pace according to the exploitation by the provider and/or according to optimization target settings—for example network resource preservation in terms of reduced load or delivery of video content with a better QoE (Quality of Experience)—and/or according to its subscription profile, for example prepaid, flatrate, gold or silver profile.

The present invention enables a more accurate calculation of rate throttling and in-advance delivery of content packets, resulting in an improvement of efficiency in finding a good match between user-experienced quality and resources consumption. The present invention allows for an intelligent delivery of content taking into account user viewing behavior and content popularity to achieve resource efficient delivery of video content.

On the basis of the present invention a provider can perform variable pacing during content delivery according to the user/content viewing statistics. The statistics could be gathered by exploiting the messages that are generated by the browser/application towards the provider or Content Service Provider (CSP) when a user performs trick-play.

Important aspects of the present invention are as follows:
Non-invasive method to generate statistics from users' trick play characteristics by exploiting existing messages.
Build statistical graphs about users' playback behavior, named ‘graphs’ in the following points.
Take these graphs into account to enable personalized delivery of content.
Take these graphs into account to find a suitable tradeoff between user QoE and saving resources in the mobile operator's transport and access network.

Further, the present invention provides a differentiated and personalized delivery of content to user's device according to user's subscription profile/contract, e.g. prepaid, flatrate, gold vs. bronze users, in addition to the graphs. For example:
Save resources by limiting in-advance delivery of content to trick play intensive low-budget user. Reduce transmission of packets, which will be omitted with a high probability. Take the risk of reduced QoE.
Prioritize improved user QoE for gold-subscribers by fast delivery of content to quickly approach a large playout buffer size, e.g. large parts or complete content buffered in advance on the user's device. Enables improved QoE even during trick-play.

The present invention provides a non-invasive method to gather fine-grain statistics on content popularity in general and sub-scene—i.e. content segment—popularity in particular. Further, on the basis of the present invention an enhancement of the accuracy estimating the buffer usage and the play-out buffer size at the user end and a personalized content delivery to save network resources or to optimize QoE is possible.

There are several ways how to design and further develop the teaching of the present invention in an advantageous way. To this end it is to be referred to the patent claims subordinate to patent claim 1 on the one hand and to the following explanation of preferred embodiments of the invention, illustrated by the drawing on the other hand. In connection with the explanation of the preferred embodiments of the invention by the aid of the drawing, generally preferred embodiments and further developments of the teaching will be explained. In the drawings

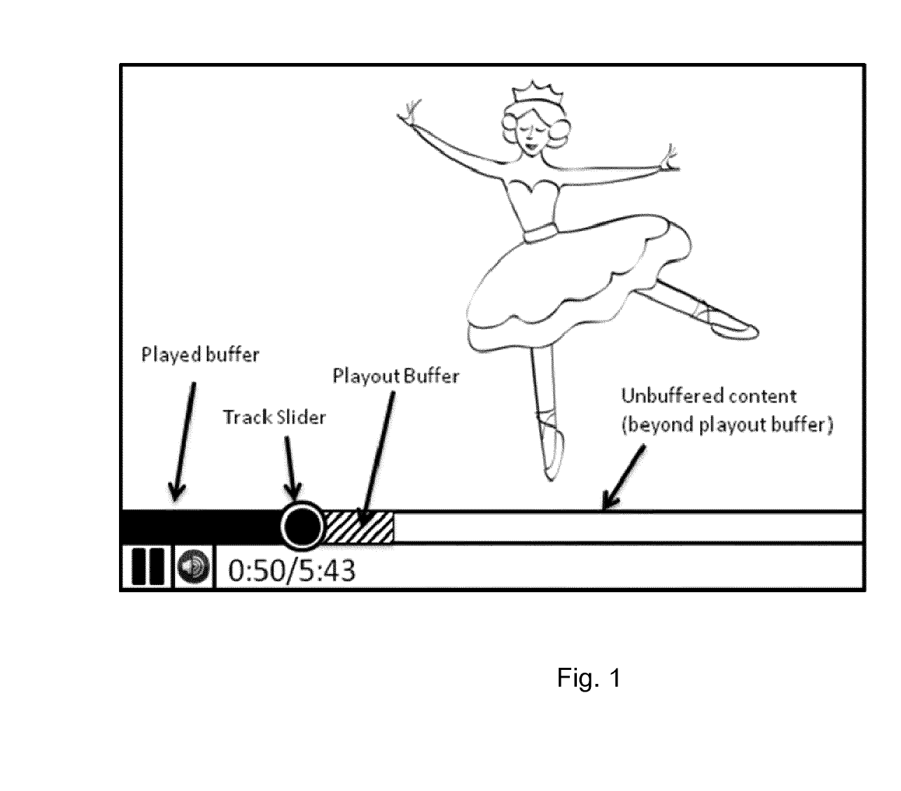

FIG. 1 is showing schematically a generic interface for video streaming viewer application,

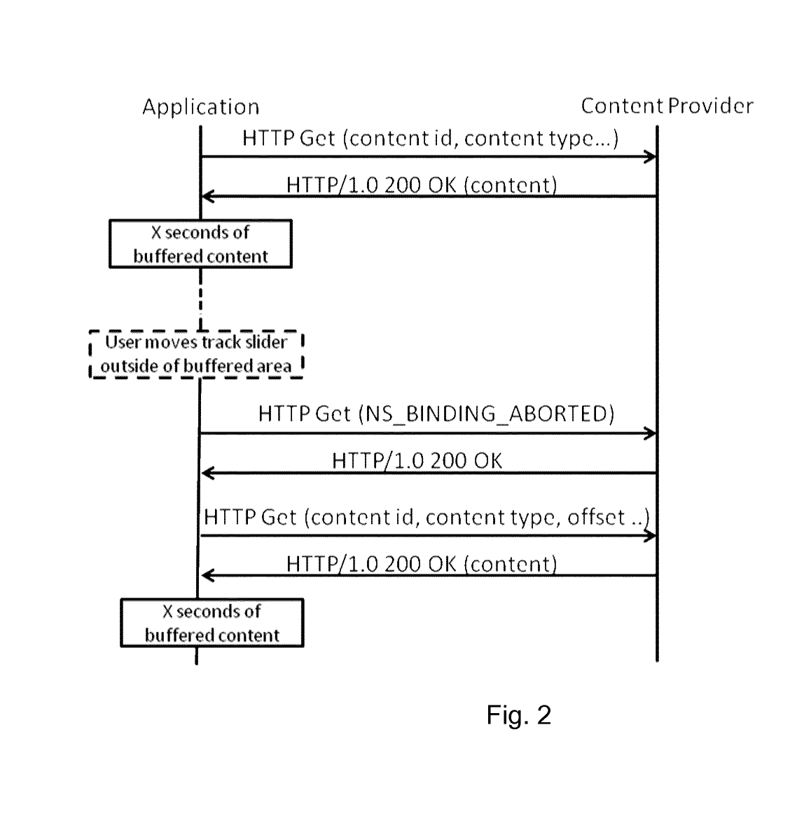

FIG. 2 is showing within a diagram a typical signaling flow for streaming content to an application and skipping outside play-out buffer,

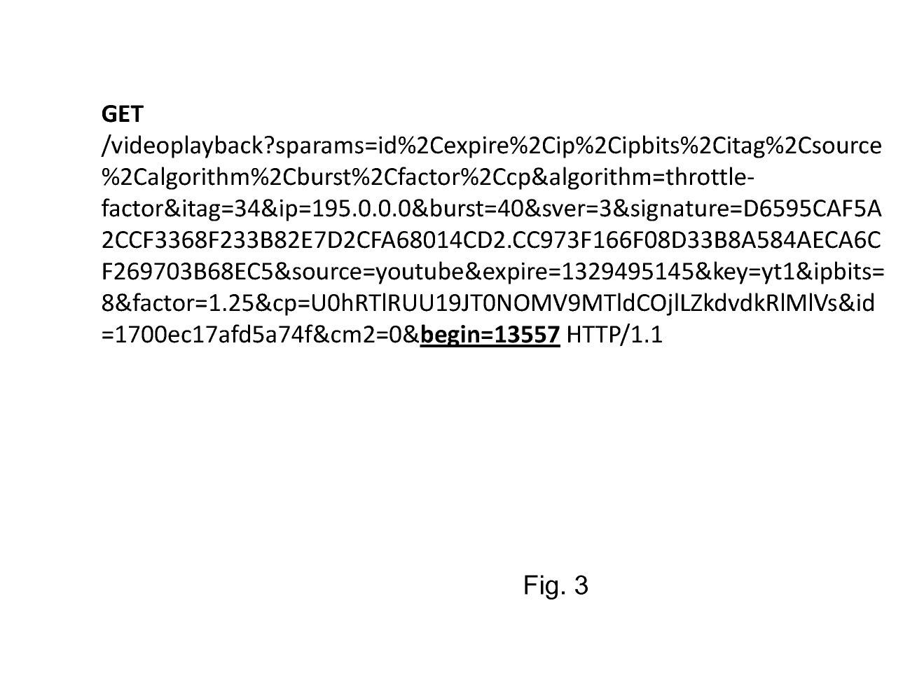

FIG. 3 is showing an example of GET request string generated after trick play showing content offset,

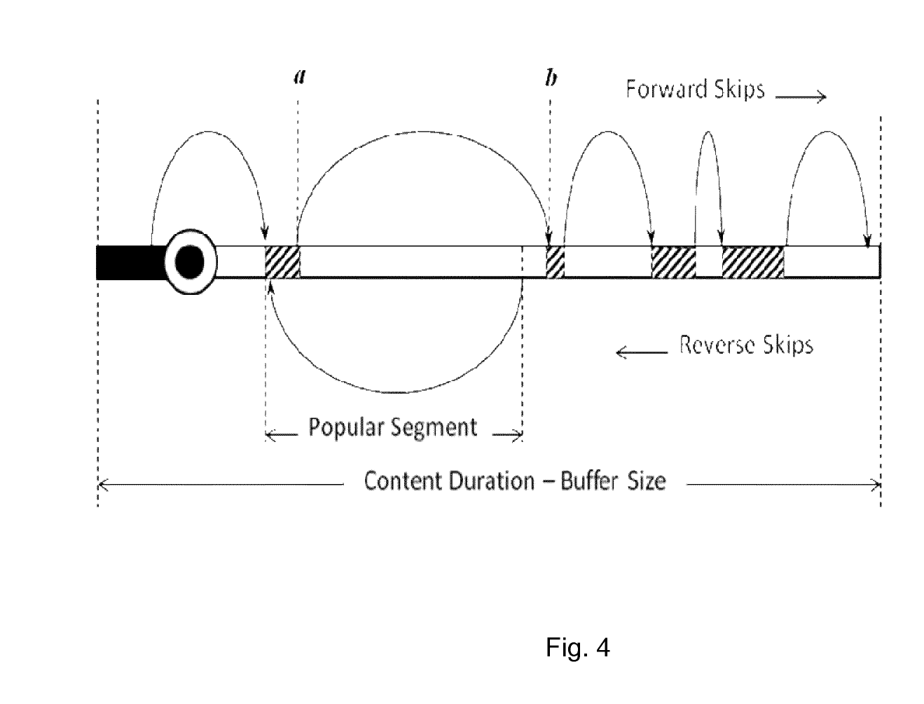

FIG. 4 is illustrating schematically a user's viewing behavior and determination of popular content segment,

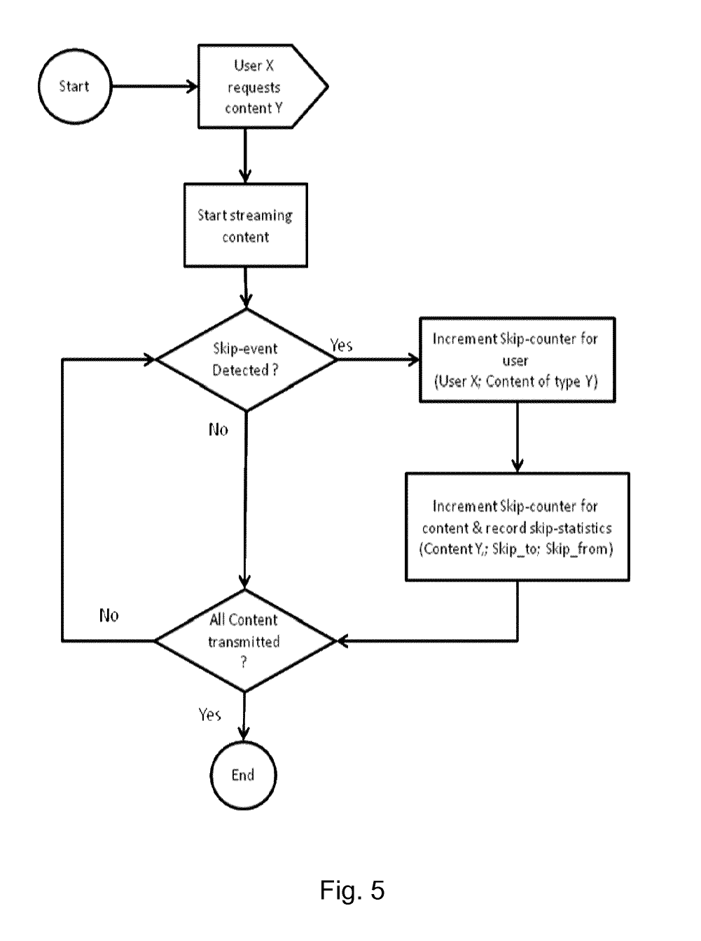

FIG. 5 is showing within a block diagram a learning phase for gathering trick play information according to the invention and

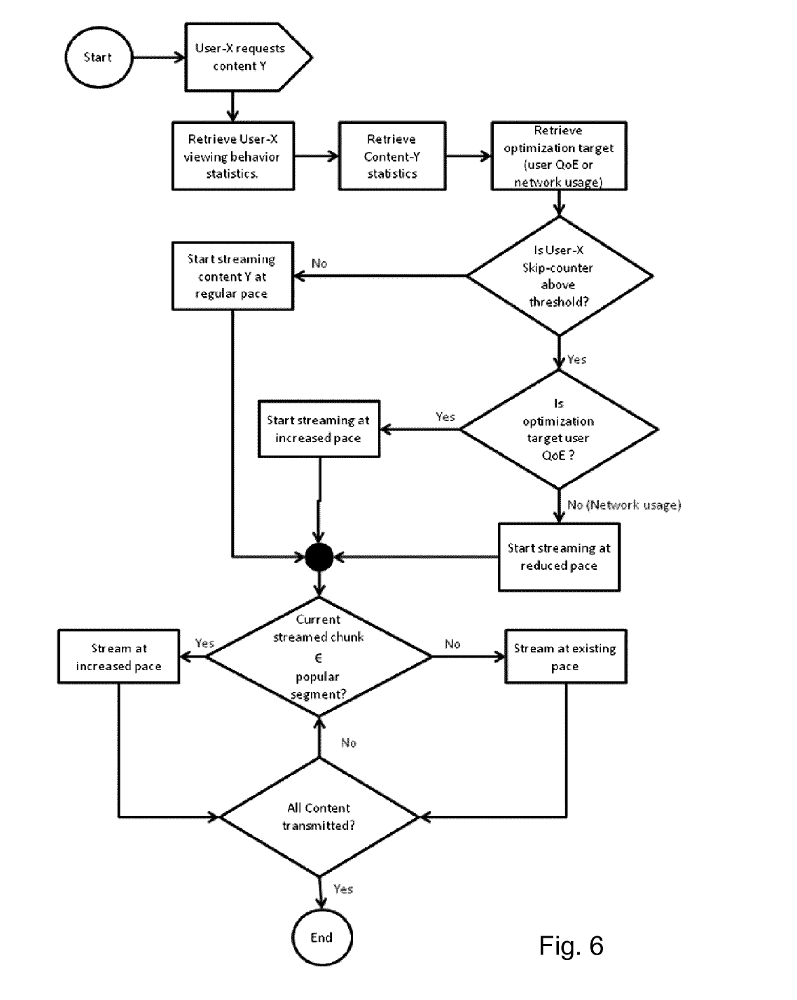

FIG. 6 is showing within a flow chart/logic diagram an enhanced streaming with variable delivery pace according to the invention.

According to the claimed method a provider exploits information transmitted between the user and the provider due to the execution of a trick play function by the user. Such an information will be used by the provider for scheduling the delivery from the provider to the user via a network.

The invention provides a non-invasive fine-granular method by means of which CPs or Mobile Contend Delivery Networks (mCDN) operators, referred to as providers or Content Service Providers (CSP) in text, can derive a more accurate popularity estimation based on recording user behavior while they perform trick play while viewing a particular video content. Such a method will not only help determine a content popularity in general but it also gives a more granular way of determining the popularity of a particular segment within the content. Based on the popularity and derived statistics of user behavior while downloading and viewing content, on a per user and per content basis, the CSPs will be able to efficiently and intelligently deliver contents to users resulting in saving of network and cache resources. This is of particular importance in the context of mobile networks.

The invention leverages the message or messages that the browser/application on the client sends towards the CSP each time a user executes a trick play function. A trick play is a function when a user manually moves the track-slider forward or backward to view the scene of his/her choice.

FIG. 1 shows a generic video player interface depicting the progressive delivery of content. Each time the track slider is advanced beyond or outside the play-out buffer, either forward or backward, the following actions ensue:
1. The browser sends out a message to the content server or provider that will abort the current progressive-download session, e.g., NS_BINDING_ABORTED message in case of Youtube, Daily Motion.
2. A new HTTP GET message is generated that indicates the new position of the track-slider and the content server or provider will initiate a new progressive-download session from this position onwards.
3. The previously buffered packets are discarded from the playout buffer.

The above are important steps although there may be some variations depending on the CSP. As an example, normal Youtube signaling flow is depicted in FIG. 2, whereas FIG. 3 shows a typical HTTP GET request string specify the content offset—the string “begin=13557” in FIG. 3—after a user performs trick play.

The claimed method enables the CSPs to preferably statistically exploit the information embedded in this process to non-invasively achieve the following objectives:
1. Determine user or a group of users behavior in relation to content type.
2. Determine user or a group of users viewing behavior by setting thresholds on number of skips and subsequently classifying the user.
3. Determine content popularity based on the number of times a user performs trick play.
4. Determine the popularity of sub-segments within a content based on how many users and/or how many times a user advance to re-view a particular segment of a scene.
5. Deliver the content in a differentiated and personalized pacing according to statistics collected of user behavior.
6. Improved estimation of the buffer utilization at the UE without any explicit messaging.

With the above information a CSP can have greater control in regulating and/or scheduling the delivery of requested content in many ways. Such regulated and discriminate delivery of content will enable targeted distribution of content resulting in lower cost of delivering content to the users. Based on the individual user statistics and/or the content statistics, it will also extend to CSP the control to balance between preserving network load resources—both core and access—and a user QoE.

This is illustrated in FIG. 4, which shows a user with a viewing behavior manifesting frequent skipping within the content. The CSP can then fill the playout buffer faster with just enough content chunks for the duration of the segment, after which the user is expected to or might skip forward, while progressively delivering subsequent chunks at a less than average rate. Such judicious delivery of content will result in network resource preservation in terms of reduced load, without guaranteeing the user QoE, for example, in case when a user does not skip and hence experience a brief freeze until the playout buffer has sufficient content chunks to resume normal playing.

On the other hand, from the point of view of delivering content with a better QoE, the network can continue to send content chunks at a higher than average rate in order to preempt a user skip-event by ensuring the availability of chunks in the playout buffer in order to ensure seamless continuation of content viewing during skip-event(s).

Taking advantage of the metadata that is conveyed by the content player message(s), e.g., NS_BINDING_ABORTED and the subsequent HTTP GET request in the case of YouTube, the CSP can not only keep track of the skip-events, for example, by maintaining a skip-counter—for both user and content, but also track the skip location within the content. For example, as illustrated in FIG. 4, the skip-event can be generally classified as Forward-Skip and Reverse-Skip. Each skip event can be characterized by a Skip-from—represented by “a” in FIG. 4—and Skip-to—represented by “b” in FIG. 4—parameters. The Skip-from and Skip-to parameters can help determine the Skip-size. A separate counter can be maintained for each skip-event that gets incremented each time a user skips through the content. Content with a higher counter value for Forward-skip would generally imply un-popular content, while content with a higher counter value for Reverse-skip can be deemed popular. The parameters associated with the Reverse-skip can also determine the popular segment within content. One manifestation of this approach could be for the CSP to transmit the content chunks pertaining to the popular segment at a higher than average rate with respect to other chunks of the same content.

The internal behavior for the learning phase is depicted in FIG. 5. After a certain user requests some content stream, the system keeps track of how many times the user skips and also the respective skip times, indicating from/to. This is recorded until the streaming finishes or the user stops the streaming.

FIG. 6 shows the streaming of content for which there were statistics—user and content related—available based on a previous learning phase. Initially a user requests a particular content and the respective user and content statistics are retrieved. Also the type of optimization target is retrieved i.e., whether to preserve network resources or uphold user QoE. After that the user will receive the stream at a normal, increased or decreased pace according to different values of the statistics and optimization target settings.

Based on the method embodied by the invention, the following advantages are possible:
1) Gather statistics on user's viewing behavior.
2) A more reliable and fine-grained method of determining content popularity based on user's reaction to browsing content data, rather than depending on the number of hits/comments etc. a content receives.
3) Enable CSPs or providers to make the data availability selective and content distribution intelligent.
4) The selective availability and intelligent delivery of content will reduce load on the network's core and access while also reducing caching cost.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for determining user behavior during delivery of video content, wherein a user is requesting a delivery of a video content from a provider via a network,
characterized in that the provider exploits information transmitted between the user and the provider due to the execution of a trick play function by the user for scheduling the delivery and/or determining video content popularity and/or user behavior.

2. A method according to claim 1, wherein the exploitation will be performed on a per user basis.

3. A method according to claim 1, wherein the exploitation will be performed on a per video content basis.

4. A method according to claim 1, wherein the provider records user behavior during trick play while the user is downloading and/or viewing the video content.

5. A method according to claim 1, wherein the information comprises a message or messages that a browser or an appropriate application on the user side sends towards the provider when the user executes a trick play function.

6. A method according to claim 5, wherein the message will be generated each time a track slider is advanced beyond or outside a play-out buffer.

7. A method according to claim 1, wherein the exploitation will be performed statistically.

8. A method according to claim 1, wherein the exploitation comprises the determination of a user or group of user behavior or viewing behavior in relation to the video content or video content type.

9. A method according to claim 1, wherein the exploitation comprises the determination of a user or group of user behavior or viewing behavior by setting thresholds on number of skips and subsequently classifying the user and/or classifying the video content.

10. A method according to claim 1, wherein the exploitation comprises the determination of video content popularity based on the number of times a user executes the trick play function.

11. A method according to claim 1, wherein the exploitation comprises the determination of the popularity of sub-segments within a video content based on how many users and/or how many times a user advances forwards and/or backwards to re-view a particular segment of a scene or video content and/or skip over a particular segment of a segment, scene or video content.

12. A method according to claim 1, wherein the exploitation comprises the possibility of delivering the video content in a differentiated and/or personalized pacing.

13. A method according to claim 1, wherein the exploitation comprises an estimation of a buffer utilization at a user or UE (User Equipment).

14. A method according to claim 1, wherein the provider delivers content chunks of a definable and/or popular segment of the video content at a higher rate than of other segments.

15. A method according to claim 14, wherein the definable and/or popular segment is a segment after which the user is expected to or might skip forward or backward.

16. A method according to claim 14, wherein the definable and/or popular segment is a segment into which the user is expected to or might skip forward or backward.

17. A method according to claim 1, wherein the information comprises a number of skip events and/or a skip location within the video content.

18. A method according to claim 1, wherein the information comprises the starting and the end point of a skip event within the video content.

19. A method according to claim 1, wherein the information comprises the skip direction within the video content.

20. A method according to claim 1, wherein the user receives a video content stream at a normal, variable, increased or decreased pace according to the exploitation by the provider and/or according to optimization target settings and/or according to its subscription profile.

21. A network, preferably for carrying out the method for determining user behavior during delivery of video content according to claim 1, wherein a user is requesting a delivery of a video content from a provider via the network, characterized in that the provider comprises means for exploiting information transmitted between the user and the provider due to the execution of a trick play function by the user for scheduling the delivery and/or determining video content popularity and/or user behavior.
